(19) United States
(12) Patent Application Publication
(10) Pub. No.: US 2007/0121469 A1
(43) Pub. Date: May 31, 2007

(54) HOLOGRAPHIC OPTICAL PICKUP APPARATUS

(75) Inventor: Shinnosuke Torii, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/562,588

(22) Filed: Nov. 22, 2006

(30) Foreign Application Priority Data
Nov. 29, 2005 (JP) 2005-343883

(51) Int. Cl. G11B 7/00

(52) U.S. Cl. 369/112.01; 369/44.23

(57) ABSTRACT

Provided is a holographic optical pickup apparatus which can be reduced in thickness and production cost while having a beam shaping unit. To be specific, in a holographic optical pickup apparatus based on a holographic memory technique, a beam shaping prism for extending a short axis of light with elliptical cross section emitted from a light source is disposed between a spatial light modulator (SLM) and an objective lens. Thereby, a light beam incident on the spatial light modulator (SLM) has an elliptical cross section and is small in diameter, so that the spatial light modulator can be reduced in size and cost.

### BACKGROUND OF THE INVENTION

1. Field of the Invention

The present invention relates to a holographic optical pickup apparatus for recording or reproducing information to or from a recording medium by a holographic optical memory system.

2. Description of the Related Art

In recent years, for super-high density optical recording, volume holography, in particular, digital volume holography has been practically developed and attention has been focused thereon. The term “volume holography” refers to a system for three-dimensionally writing an interference pattern on a recording medium by utilizing a thickness direction thereof as well.

The system is advantageous in that the diffraction efficiency can be improved by an increase in thickness and the recording capacity can be increased using multiple recording. Further, the term “digital volume holography” refers to a holographic recording system in which image information to be recorded is limited to a binarized digital pattern, while using the same recording medium and recording system as those in the case of the volume holography.

In the digital volume holography, for example, even image information such as an analog picture is temporarily developed to two-dimensional digital pattern information, which is then recorded as image information. At the time of reproduction, the digital pattern information is read out and decoded, so that the original image information is obtained and displayed.

Examples of the technique of realizing the digital volume holography which have been proposed include: a two-beam interference method of allowing information light and reference light to separately enter a recording medium at different irradiation angles and recording an interference pattern therebetween; and a collinear system for allowing information light and reference light to coaxially enter a recording medium.

Further, as a light source for realizing such optical systems as described above, it is desirable to use a semiconductor laser from the viewpoint of reduction of cost and ease of handling.

However, since light emitted from a semiconductor laser has an elliptical cross section, the short axis of the emitted light having the elliptical cross section has been hitherto extended by a beam shaping means such as a beam shaping prism to form the emitted light in a circular shape.

A technique using the beam shaping means is disclosed in, for example, ISOM/ODS 2005 which is an international conference. FIG. 7 shows a collinear optical system as shown in FIG. 1 in ThE3 “Optical Collinear Holographic Recording System Using a Blue Laser and a Random Phase Mask”.

FIG. 8 shows an optical system based on a two-beam interference method as shown in FIG. 2 in ThE5 “Temperature Tolerance Improvement with Wavelength Tuning Laser Source in Holographic Data Storage”. As can be seen from FIGS. 7 and 8, the beam shaping element is disposed in the vicinity of the light source (beam shaping element being a prism in each of FIGS. 7 and 8).

Next, a collinear optical system according to a conventional example will be described in detail with reference to FIG. 9. First, the case where recording is performed on a hologram medium 216 which is a recording medium will be described. A light beam emitted from a green laser 201 serving as a light source is converted into a parallel light beam by a collimator 202. Then, the parallel light beam is incident on a beam shaping prism 301 serving as a beam shaping means, whereby the short-axis of an exiting light beam having an elliptical cross section is extended.

After that, the light beam is reflected by a mirror 203 to illuminate a spatial light modulator (SLM) 204. In the example shown in FIG. 9, a deformable mirror device (DMD) is used as the SLM 204. A light beam reflected by a pixel indicating information of “1” on the SLM 204 is reflected toward the hologram medium 216, while a light beam reflected by a pixel indicating information of “0” is not reflected toward the hologram medium 216. On the collinear-system SLM 204, there are provided a portion for modulating information light 206 and another portion for modulating reference light 205 which circularly surrounds the portion for modulating information light 206.

The reference light 205 and the information light 206 reflected by the pixel indicating the information of “1” on the SLM 204 pass through a polarization beam splitter (PBS) 207 in p-polarization and travel toward the hologram medium 216 through a relay lens-1 208, a mirror 209, a relay lens-2 210, and a dichroic beam splitter (DBS) 211.

Further, at that time, the reference light 205 and the information light 206, which have been converted into circular polarizing lights (for example, right-hand circular polarizing lights) by passing through a quarter-wave plate (QWP) 212, are reflected by a mirror 213 and then incident on an objective lens 214 having a focal length F. A pattern displayed on the SLM 204 passes through the two relay lenses 208 and 210 to form an intermediate image at a distance of F before the objective lens 214. Thereby, an pattern image (not shown) of the SLM 204, the objective lens 214 and the hologram medium 216 are disposed distant from one another by the distance of F, thereby constructing a so-called 4F optical system.

The hologram medium 216 has a disk shape and is held by a spindle motor 215 so as to be rotatable. The reference light 205 and the information light 206 are condensed on the hologram medium 216 by the objective lens 214 to produce an interference fringe by interference therebetween. An interference fringe pattern at the time of recording is recorded as a refractive index distribution in a polymer material of the hologram medium to form a digital volume hologram. Further, the hologram medium has a reflective film provided therein.

In addition to the green laser 201 for performing hologram recording/reproduction, a red laser 220 for emitting light to which the hologram medium is non-photosensitive is provided, whereby a displacement of the hologram medium 216 relative to the reflective film set as a reference surface can be detected with high precision. Thereby, even when the hologram medium 216 is subjected to axial deflection or radial runout, it is possible to cause a recording spot to dynamically follow a medium surface using an optical servo technique, so that the interference fringe pattern can be recorded with high precision. Hereinafter, a brief description will be given.

A linear polarizing light beam emitted from the red laser 220 passes through a beam splitter (BS) 221 and is then converted into a parallel light beam by a lens 222. The light beam is reflected by a mirror 223 and the dichroic beam splitter (DBS) 211 to travel toward the hologram medium 216. Further, the light beam which has been converted into circular polarizing light (for example, right-hand circular polarizing light) by passing through the quarter-wave plate (QWP) 212 is reflected by the mirror 213 and is then incident on the objective lens 214. The incident light beam is condensed as a very small light spot on the reflective surface of the hologram medium 216.

The reflected light beam becomes circular polarizing light of the opposite rotation (for example, left-hand circular polarizing light) and is incident on the objective lens 214 again to be converted into a parallel light beam. The light beam is reflected by the mirror 213 and passes through the quarter-wave plate (QWP) 212 to be converted into a linear polarizing light beam which is perpendicular to the light beam traveling on the approach path to the hologram medium 216. The light beam reflected by the dichroic beam splitter (DBS) 211 passes through the mirror 223 and the lens 222 as in the case of the approach path. Then, the light beam is reflected by the beam splitter (BS) 221 and guided to a servo photodetector 224. The servo photodetector 224 has a plurality of light receiving surfaces (not shown) and detects position information on the reflective surface using a known method, based on which the focus control and tracking control of the objective lens 214 can be performed.

Next, an operation in the case where recording information is reproduced from the hologram medium 216 serving as the recording medium by use of the above-mentioned optical system will be described. A light beam emitted from the green laser 201 serving as the light source illuminates the spatial light modulator (SLM) 204 as is the case with recording. At the time of the reproduction, only the portion for modulating the reference light 205 on the SLM 204 displays the information of “1” and all the portion for modulating the information light 206 displays the information of “0”. Therefore, only light reflected by pixels corresponding to the portion for the reference light is reflected toward the hologram medium 216, while the information light is not reflected toward the hologram medium 216.

As is the case with the recording, the reference light 205 is converted into circular polarizing light (for example, right-hand circular polarizing light) and condensed on a recording medium on a disk (not shown) to reproduce information light, which is reproduced light, from the recorded interference fringe pattern. The information light which has been reflected by the reflective film of the recording medium becomes circular polarizing light of the opposite rotation (for example, left-hand circular polarizing light) and is incident on the objective lens 214 again to be converted into a parallel light beam. Then, the light beam is reflected by the mirror 213 and passes through the quarter-wave plate (QWP) 212 to be converted into a linear polarizing light beam (S-polarized light) which is perpendicular to the light beam traveling on the approach path to the hologram medium 216. At this time, an intermediate image of the SLM display pattern as reproduced is formed at the distance of F from the objective lens 214.

The light beam which passed through the dichroic beam splitter (DBS) 211 travels to the polarization beam splitter (PBS) 207 through the relay lens-2 210, the mirror 209, and the relay lens-1 208. The light beam reflected by the polarization beam splitter (PBS) 207 again forms an image as an intermediate image of the SLM display pattern at a conjugate position of the spatial light modulator (SLM) 204 by the relay lens-2 210 and the relay lens-1 208.

An aperture 217 is provided in advance at the conjugate position to shield unnecessary reference light existing at the periphery of the information light. An intermediate image formed again by a lens 218 forms the SLM display pattern consisting of only the information light portion on a CMOS sensor 219 serving as a photodetector. Therefore, unnecessary reference light is not incident on the CMOS sensor 219, so that a reproduced signal having a high S/N ratio can be obtained.

Next, an optical system based on the two-beam interference method according to a conventional example will be described in detail with reference to FIG. 10. A light beam emitted from a green laser 201 serving as a light source is converted into a parallel light beam by a collimator 202. Then, the parallel light beam is incident on a beam shaping prism 301 serving as a beam shaping means to extend a short-axis of an exiting light beam having an elliptical cross section. After that, the light beam is split into a reference light 205 and an information light 206 by a beam splitter (BS) 227.

At that time, the reference light 205 passes through an objective lens-2 225 and is incident on a hologram medium 216. On the other hand, the information light 206 is incident on a spatial light modulator (SLM) 204. In the example shown in FIG. 10, a liquid crystal device having a plurality of pixels is used as the SLM 204. The information light 206 passes through the spatial light modulator (SLM) 204 and then is reflected by a mirror 203 to be projected to the hologram medium 216 through an objective lens-1 214. As a result, an interference fringe pattern formed by interference between the reference light 205 and the information light 206 is recorded in the hologram medium 216.

Here, by setting the light transmitting/shielding patterns of the respective pixels of the liquid crystal device which is the spatial light modulator (SLM) 204, desirable data can be recorded in the hologram medium 216.

When the hologram medium 216 in which the data is recorded is irradiated with only the reference light 205, the reference light 205 is diffracted by the interference fringe in the hologram medium 216. As a result, diffraction light corresponding to the pattern displayed on the liquid crystal device which is the spatial light modulator (SLM) 204 at the time of recording is generated. Therefore, when the diffraction light is condensed by an objective lens-3 226 and received by, for example, an image pickup apparatus 219 such as a CCD, the recorded data can be reproduced.

Examples of the above-mentioned holography technique include “Measurement and Nano Control Technology for supporting Holographic Memory/HVD™,” (Proceedings of 35th Meeting on Lightwave Sensing Technology, June 2005, pp. 75-82) and “Holographic Media will soon take off and 200 Gbyte will be realized in 2006” (Horigome et al, Nikkei Electronics, 2005, 1.17, pp. 105 to 114).

In the above-mentioned conventional techniques, a beam shaping means is disposed between a light source and a spatial light modulator, and light incident on the spatial light modulator has a circular shape formed by extending the short-axis of light beam with an elliptical cross section emitted from the light source. Therefore, the spatial light modulator and other optical parts which are disposed subsequent to the beam shaping means are increased in size with the increase in the light beam diameter. Further, there is also posed a problem that the spatial light modulator, the CMOS sensor, or the like is increased in cost with the increase in size thereof.

### SUMMARY OF THE INVENTION

It is, therefore, an object of the present invention to provide a holographic optical pickup apparatus which can be reduced in thickness and production cost while having a beam shaping means.

To be specific, the present invention provides a holographic optical pickup apparatus comprising: a laser light source; a spatial light modulator for separating light emitted from the laser light source into information light and reference light; an objective lens for condensing the information light and the reference light on a recording medium; a photodetector for detecting reproduced light from the recording medium; and a beam shaping element disposed between the spatial light modulator and the objective lens, for extending a short axis of light with an elliptical cross section emitted from the laser light source.

With such structure, a light beam incident on the spatial light modulator has an elliptical cross section which is smaller in diameter, so that the spatial light modulator can be reduced in size and cost.

Further, by adopting such disposition that the short-axis of the emitted light having the elliptical cross section is perpendicular to a surface of a medium, a spatial light modulator having a rectangular shape can be disposed such that a short side thereof is perpendicular to the surface of the medium, so that it is possible to reduce the thickness of a portion between the laser light source and the beam shaping means of the optical pickup apparatus.

Further features of the present invention will become apparent from the following description of exemplary embodiments with reference to the attached drawings.

### BRIEF DESCRIPTION OF THE DRAWINGS

FIG. 1 is a developed view showing an optical system of a holographic optical pickup apparatus according to Embodiment 1 of the present invention.

FIG. 2 is a perspective view showing the optical system of the optical pickup apparatus as shown in FIG. 1 which is actually disposed.

FIG. 3 is a view showing a spatial light modulator of the optical system shown in FIG. 1.

FIG. 4 is a view showing Embodiment 2 of the present invention.

FIG. 5 is a view showing Embodiment 3 of the present invention.

FIG. 6 is a view showing Embodiment 4 of the present invention.

FIG. 7 is a view showing a conventional collinear optical system.

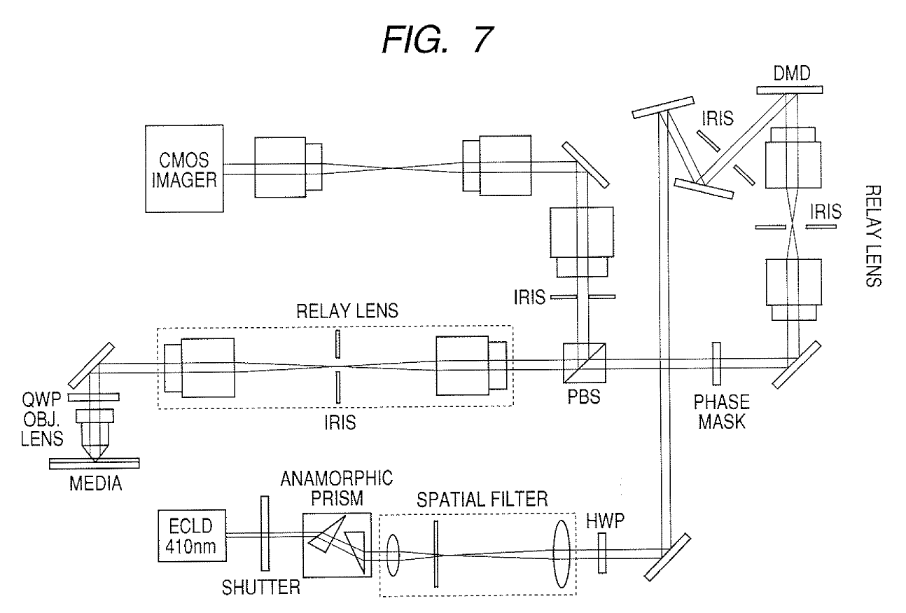

FIG. 8 is a view showing a conventional two-beam interference optical system.

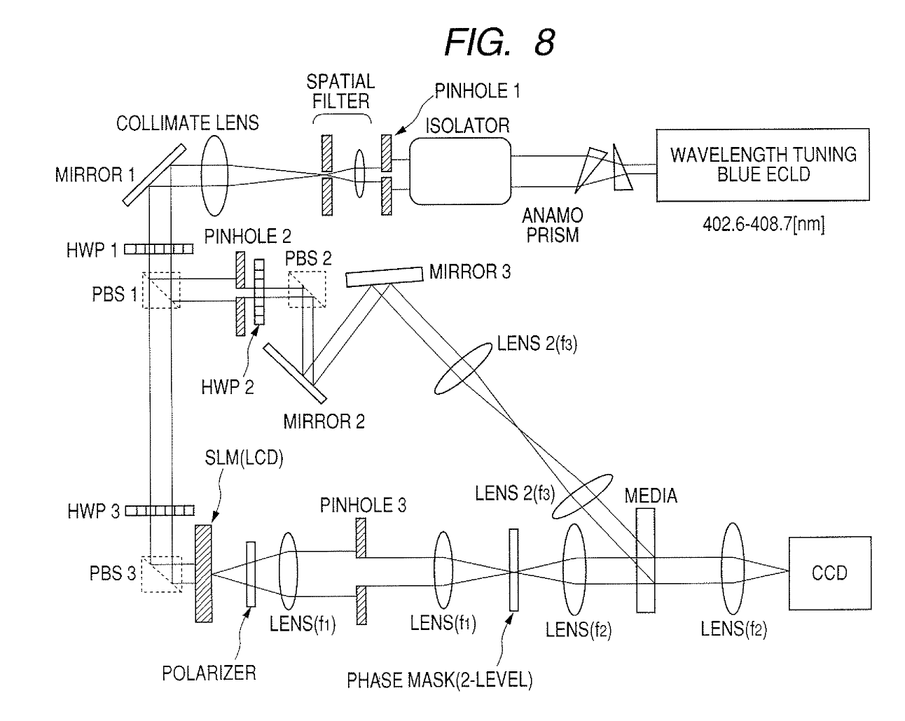

FIG. 9 is a developed view showing a collinear optical system of a conventional optical pickup apparatus.

FIG. 10 is a developed view showing a two-beam interference optical system of a conventional optical pickup apparatus.

### DESCRIPTION OF THE EMBODIMENTS

Hereinafter, embodiments for carrying out the present invention will be described in detail with reference to the attached drawings.

### Embodiment 1

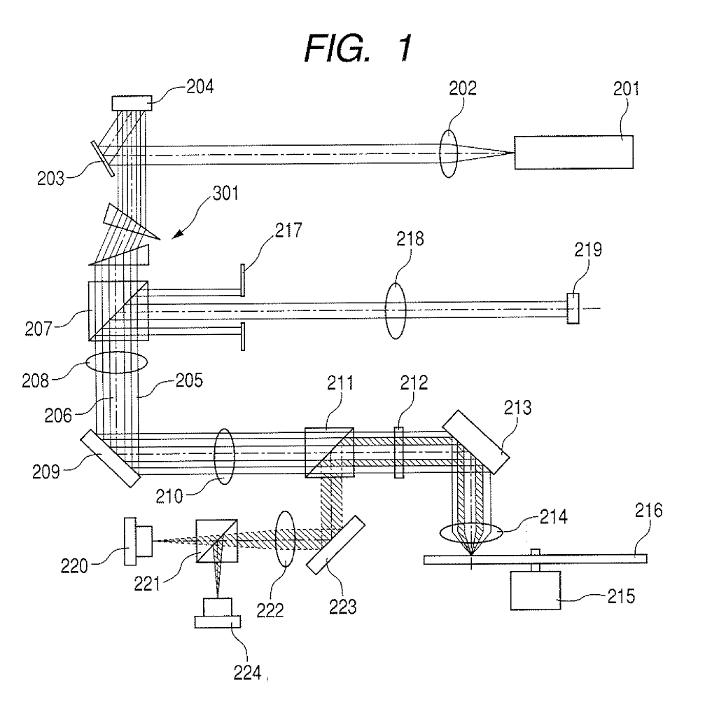

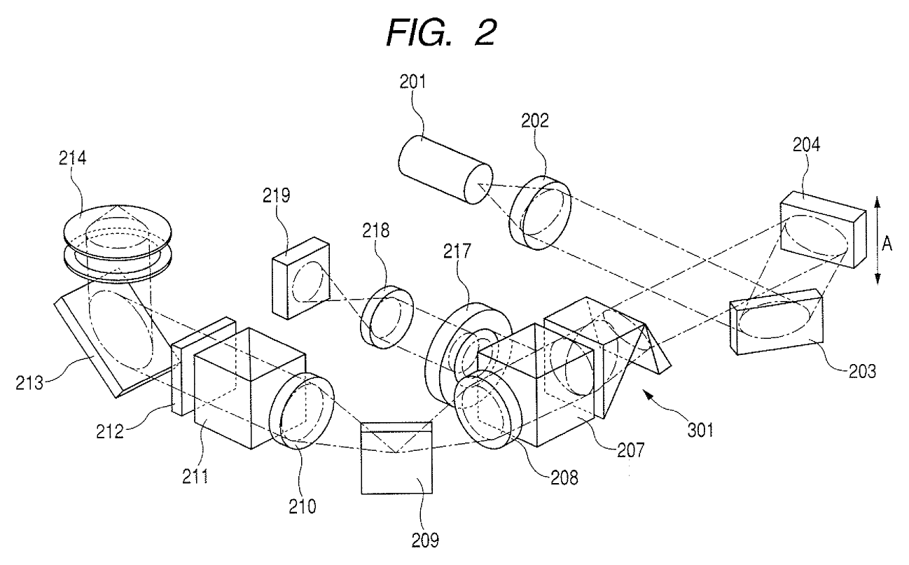

FIGS. 1 and 2 show a holographic optical pickup apparatus according to Embodiment 1 of the present invention. FIG. 1 is a developed view showing an optical system of the holographic optical pickup apparatus. FIG. 2 is a perspective view showing the optical system shown in FIG. 1, which is actually disposed in the optical pickup apparatus.

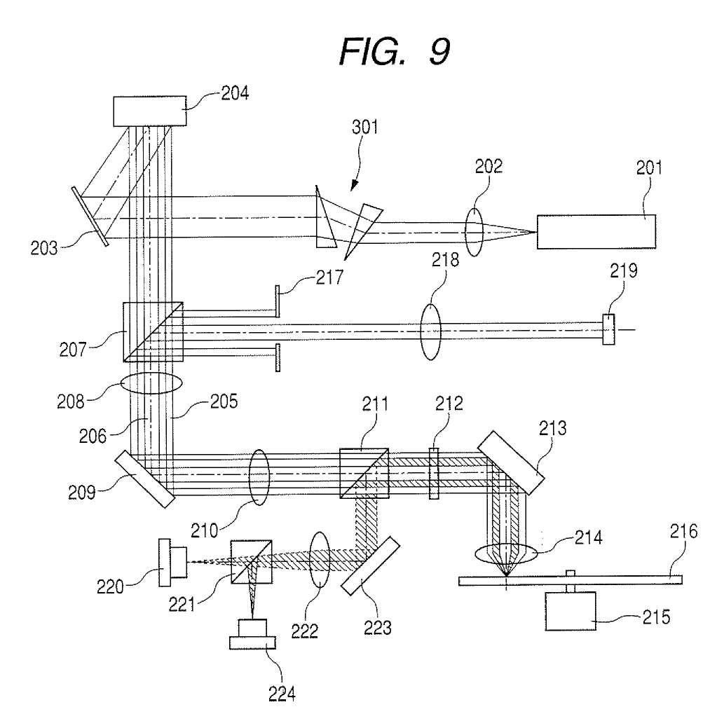

The fundamental structure shown in FIGS. 1 and 2 is identical to that of the optical system according to the conventional example as shown in FIG. 9. In FIGS. 1 and 2, the elements which are the same as those shown in FIG. 9 are identified by like numerals or symbols, and therefore detailed description thereof is omitted here. Incidentally, a hologram medium 216 having a disk shape as described later and the optical parts for performing the optical servo technique using the red laser described with reference to the conventional example are omitted in FIG. 2. In the developed view of FIG. 1, attention is focused on a short-axis of emitted light having an elliptical cross section which is a feature of the present invention. Therefore, respective optical parts in FIGS. 1 and 2 are depicted such that angles of orientation relative to optical axes thereof are different from each other. Incidentally, the term “cross section of light” herein employed refers to a cross section of light taken in a direction perpendicular to the traveling direction of the light.

In this embodiment, a beam shaping prism 301 is disposed between a spatial light modulator (SLM) 204 and a polarization beam splitter (PBS) 207 for guiding information light 206 as reproduced light to a CMOS sensor 219. A green laser 201 serving as a light source is disposed such that the short-axis of emitted light having an elliptical cross section is perpendicular (direction indicated by an arrow A in FIG. 2) to a disk surface of the hologram medium 216 having a disk shape.

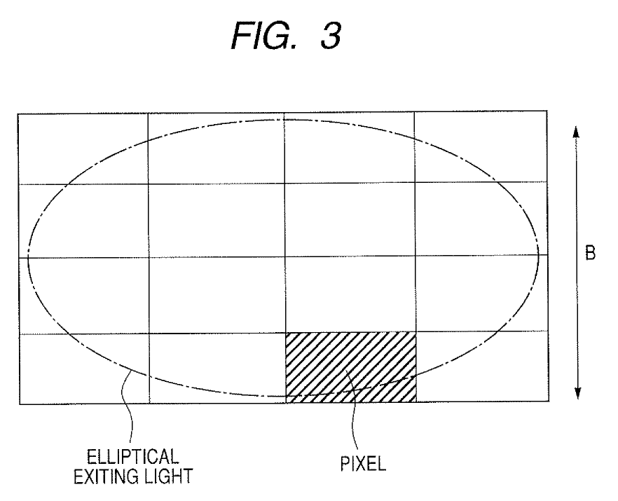

Further, as shown in FIG. 3, the spatial light modulator (SLM) 204 has a rectangular outer shape and is constituted by rectangular pixels arranged in a grid pattern. The spatial light modulator (SLM) 204 is disposed such that the direction of the short sides of the pixels and the spatial light modulator (SLM) 204 (direction indicated by an arrow B) is perpendicular to the disk surface. The outer shape (contour) of the spatial light modulator (SLM) 204 is designed so as to substantially circumscribe the light with the elliptical cross section emitted from the light source. Further, the outer shape (contour) of each of the pixels is designed so as to be similar to that of the spatial light modulator (SLM) 204.

In this embodiment, a light beam with the elliptical cross section emitted from the green laser 201 serving as the light source is converted into a parallel light beam by a collimator 202 to illuminate the spatial light modulator (SLM) 204 after reflection by a mirror 203. After that, at the time of recording, reference light 205 and the information light 206 which have been reflected by pixels indicating information of “1” on the SLM 204 are incident on the beam shaping prism 301 serving as a beam shaping means. On the other hand, at the time of reproduction, only the reference light 205 is incident on the beam shaping prism 301. Thereafter, the short axis of the emitted light having the elliptical cross sectional shape is extended. Then, the light from the beam shaping prism 301 passes through the polarization beam splitter (PBS) 207 in p-polarization and is incident on a relay lens-1 208. Incidentally, the optical system provided subsequent to the relay lens-1 208, the servo system, and the like are identical to those described with reference to FIG. 9.

With the above-mentioned structure, unlike the structure shown in FIG. 9, the shape of the light beam incident on the spatial light modulator (SLM) 204 has an elliptical cross section and is smaller in diameter, so that the spatial light modulator (SLM) 204 can be reduced in size and production cost. Further, since the light source is disposed such that the short-axis of the emitted light having the elliptical cross sectional shape is perpendicular to the disk surface, the spatial light modulator (SLM) 204 having the rectangular shape can be disposed such that the short side thereof is perpendicular to the disk surface. Therefore, as shown in FIG. 2, it is possible to reduce the thickness of at least a portion between the green laser 201 and the beam shaping prism 301 of the apparatus.

Further, by designing the shape of the pixels of the spatial light modulator (SLM) 204 so as to be similar to the outer shape of the spatial light modulator (SLM) 204, the diameter of the light beam which has been reflected by each of the pixels and passed through the beam shaping prism 301 can be made equal to that in the conventional example. Therefore, it is possible to ensure the compatibility of recording information between the apparatus according to the conventional example and the optical pickup apparatus according to the present invention.

### Embodiment 2

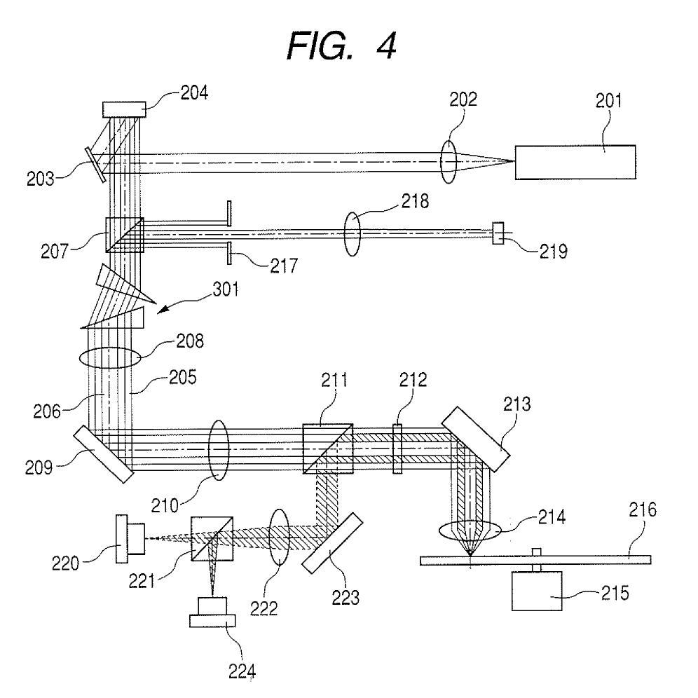

FIG. 4 is a view showing Embodiment 2 of the present invention. FIG. 4 is a developed view showing an optical system of a holographic optical pickup apparatus according to this embodiment. The fundamental structure is identical to that shown in FIGS. 1 and 2. In FIG. 4, the elements which are the same as those shown in FIGS. 1 and 2 are identified by like numerals or symbols, and therefore detailed description thereof is omitted here.

In this embodiment, a beam shaping prism 301 is disposed between a PBS 207 located subsequent to the spatial light modulator (SLM) 204, for guiding information light 206 as reproduced light to a CMOS sensor 219, and a relay lens-1 208.

Next, a feature of the present embodiment will be described. At the time of reproduction, each of the information light 206 and the reference light 205 which are reproduced from the disk-shaped hologram medium 216 becomes circular polarizing light (for example, left-hand circular polarizing light) with a rotation opposite to that of the light traveling on the approach path to the hologram medium 216.

Then, the light is incident on the objective lens 214 again to be converted into a parallel light beam. The light beam is reflected by a mirror 213 and passes through a quarter-wave plate (QWP) 212 to be converted into a linear polarizing light beam (s-polarized light) which is perpendicular to the light beam traveling on the approach path to the hologram medium 216. At this time, an intermediate image of the SLM display pattern as reproduced is formed at the distance of F from the objective lens 214.

The light beam passing through the dichroic beam splitter (DBS) 211 is incident on the beam shaping prism 301 again through the relay lens-2 210, the mirror 209, and the relay lens-1 208. Thereby, contrary to the case of the approach path, the light beam incident on the beam shaping prism 301 comes to have an elliptical cross sectional shape because of a size reduction in one axial direction thereof, and the light beam having the elliptical cross section travels toward the polarization beam splitter (PBS) 207. After that, the light beam reflected by the PBS 207 again forms an image as an intermediate image of the SLM display pattern at a conjugate position of the SLM 204 by the relay lens-2 210 and the relay lens-1 208.

An aperture 217 is provided in advance at the conjugate position to shield unnecessary reference light existing at the periphery of the information light. Thereby, an intermediate image formed again by a lens 218 forms the SLM display pattern consisting of only the information light portion on a CMOS sensor 219 serving as a photodetector.

With the above-mentioned structure, in addition to the effects described in Embodiment 1, each of the PBS 207, the aperture 217, and the CMOS sensor 219 can be reduced in size and thickness. In particular, since the CMOS sensor 219 is a high-cost optical element, the cost reduction thereof resulting from the size reduction is very advantageous.

### Embodiment 3

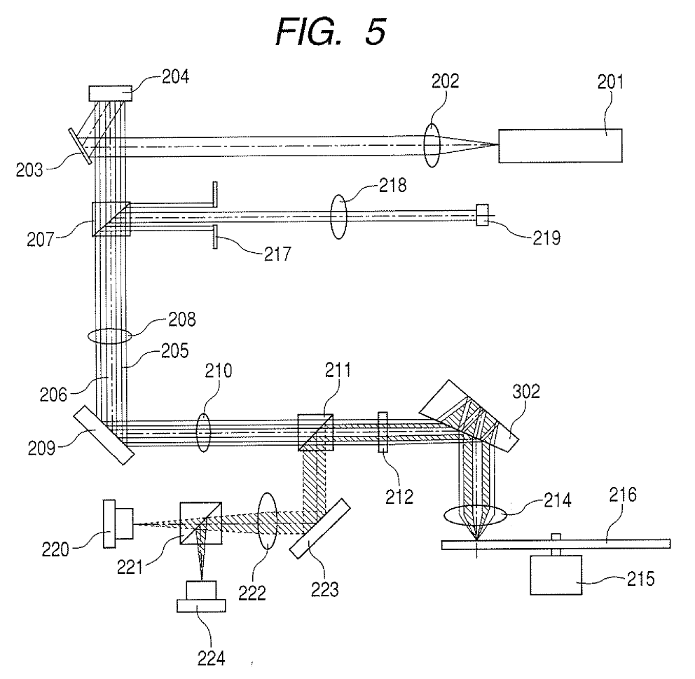

FIG. 5 is a view showing Embodiment 3 of the present invention. FIG. 5 is a developed view showing an optical system of an optical pickup apparatus according to this embodiment. The fundamental structure is identical to that of the optical system in Embodiment 1. In FIG. 5, the elements which are the same as those shown in FIGS. 1 and 2 are identified by like numerals or symbols, and therefore detailed description thereof is omitted here.

In this embodiment, a beam shaping mirror 302 is used as the beams shaping means and disposed between an objective lens 214 and a QWP 212. Therefore, the light beam emitted from a red laser 220 for optical servo, which is normally a semiconductor laser, can also be shaped therewith, so that the quality of red laser light for servo can be improved. Thus, in this embodiment, the red laser 220 is desirably disposed such that a short-axis of light having an elliptical sectional shape emitted therefrom is extended by the beam shaping mirror 302.

Further, with the above-mentioned structure, a conventional mirror 213 can be removed, so that the production cost of the apparatus can be reduced corresponding thereto. Moreover, as compared with Embodiment 2, all the optical elements located between a relay lens-1 208 and the QWP 212 can be reduced in size, so that the apparatus can be further reduced in size, thickness, and cost.

In this embodiment, the beam shaping mirror 302 is used as the beams shaping means. However, the present invention is not limited thereto. Therefore, for example, even when a reflection type diffraction grating is used, the same effects can be obtained.

### Embodiment 4

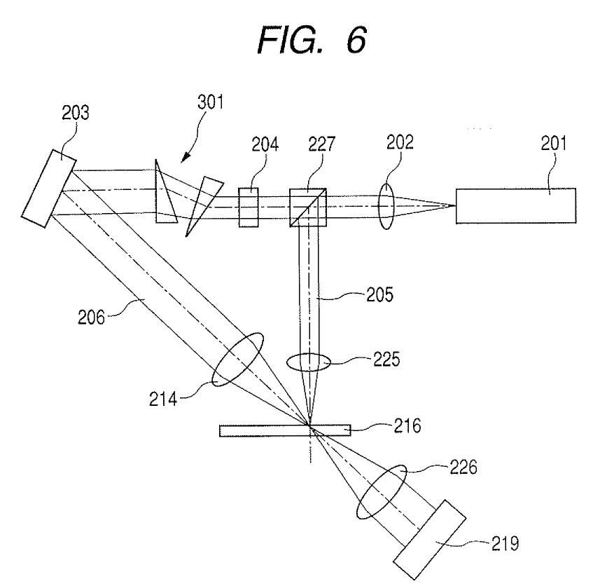

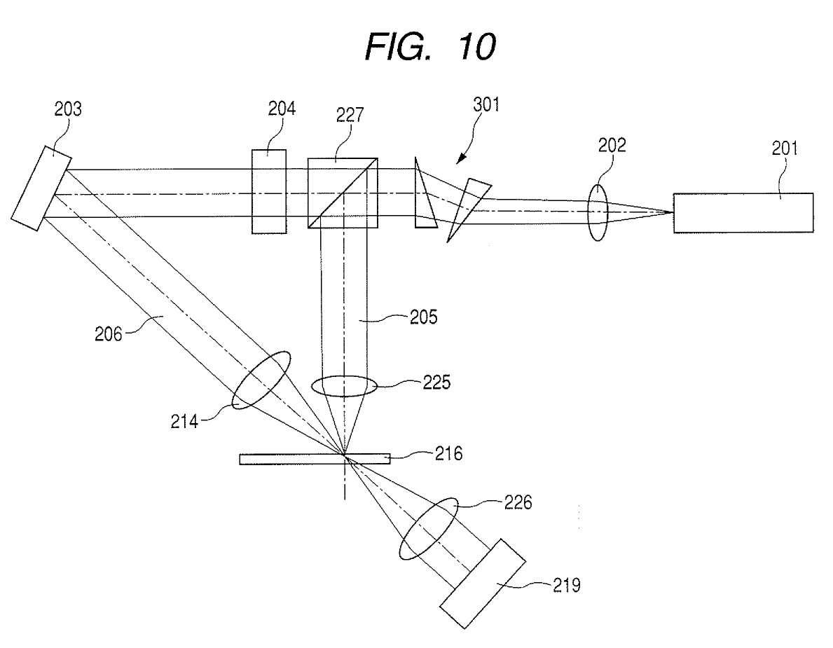

FIG. 6 is a view showing Embodiment 4 of the present invention. FIG. 6 is a developed view showing an optical system of an optical pickup apparatus according to this embodiment. The fundamental structure is identical to that of the optical system according to the conventional example as shown in FIG. 10. In FIG. 6, the elements which are the same as those shown in FIG. 10 are identified by like numerals or symbols, and therefore detailed description thereof is omitted here.

In this embodiment, a beam shaping prism 301 is disposed between a liquid crystal device which is a spatial light modulator (SLM) 204 and a mirror 203. With such a configuration, as compared with the case shown in FIG. 10, not only a reduction in effective light beam diameter of an optical system between a collimator 202 and the spatial light modulator (SLM) 204 but also a reduction in effective light beam diameter of an optical system between a beam splitter (BS) 227 and an objective lens-2 225 for condensing a reference light 205 on the hologram medium 216 can be attained, whereby reduction in cost can be realized.

Further, as is the case with Embodiment 1, by adopting such disposition that the short-axis of emitted light having an elliptical cross sectional shape is perpendicular to a recording medium surface, the spatial light modulator (SLM) 204 having the rectangular shape can be disposed such that the short side thereof is perpendicular to the medium surface. Therefore, the thickness of the entire apparatus can also be reduced. Moreover, by disposing the beam shaping prism 301 between the objective lens-1 214 and the mirror 203, the mirror 203 can also be reduced in size and cost.

The present invention is not limited to only the above-mentioned embodiments. For example, other than the green laser as mentioned above, a blue-violet semiconductor laser which has been put to practical use in recent years can be used as the holographic light source. Further, it is to be understood that not only a disk-shaped medium but also a card-shaped medium or the like can be used as the hologram medium.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-343883, filed Nov. 29, 2005, which is hereby incorporated by reference herein in its entirety.

What is claimed is:

1. A holographic optical pickup apparatus comprising:
a laser light source;
a spatial light modulator for separating light emitted from the laser light source into information light and reference light;
an objective lens for condensing the information light and the reference light on a recording medium;
a photodetector for detecting reproduced light from the recording medium; and
a beam shaping element disposed between the spatial light modulator and the objective lens, for extending a short axis of light with an elliptical cross section emitted from the laser light source.

2. The holographic optical pickup apparatus according to claim 1, further comprising a beam splitting element disposed between the spatial light modulator and the objective lens, for guiding the reproduced light to the photodetector, wherein the beam shaping element is disposed between the beam splitting element and the objective lens.

3. The holographic optical pickup apparatus according to claim 1, wherein the laser light source is disposed such that a short-axis of the emitted light with the elliptical cross section is perpendicular to a surface of the recording medium.

4. The holographic optical pickup apparatus according to claim 1, wherein the spatial light modulator has a rectangular outer shape and is disposed such that a short side of the rectangular outer shape is perpendicular to a surface of the recording medium.

5. The holographic optical pickup apparatus according to claim 4, wherein the rectangular outer shape of the spatial light modulator circumscribes the light with the elliptical cross section emitted from the laser light source.

6. The holographic optical pickup apparatus according to claim 4, wherein the spatial light modulator is constituted by a plurality of rectangular pixels and a short side of each of the pixels is perpendicular to the surface of the recording medium.

7. The holographic optical pickup apparatus according to claim 6, wherein each of the pixels has a shape similar to the outer shape of the spatial light modulator.

8. The holographic optical pickup apparatus according to claim 1, wherein the beam shaping element is a beam shaping mirror and is disposed on a light incident side of the objective lens.
